(19) United States
(12) Patent Application Publication
(10) Pub. No.: US 2023/0403426 A1
(43) Pub. Date: Dec. 14, 2023

(54) SYSTEM AND METHOD FOR INCORPORATING AUDIO INTO AUDIOVISUAL CONTENT

(71) Applicant: Meta Platforms, Inc., Menlo Park, CA (US)

(72) Inventors: Andrew Lovitt, Redmond, WA (US); Salvael Ortega Estrada, Cedar Park, TX (US)

(73) Assignee: Meta Platforms, Inc., Menlo Park, CA (US)

(21) Appl. No.: 17/746,873

(22) Filed: May 17, 2022

(51) Int. Cl. H04N 21/43; H04N 21/439; H04N 21/845

(52) U.S. Cl. CPC H04N 21/4307; H04N 21/8455; H04N 21/8456; H04N 21/4394

(57) ABSTRACT

In some embodiments, a method includes detecting an incorporation attribute of audiovisual content; analyzing an audio library to determine an audio file that maps to the incorporation attribute; selecting the audio file from the audio library that maps to the incorporation attribute; incorporating the selected audio file into the audiovisual content to generate egocentric audiovisual content; and providing the egocentric audiovisual content to a user for audiovisual consumption. In some embodiments of the method, the incorporation attribute is at least one of a mood of a target of the audiovisual content, an activity of the target of the audiovisual content, and a background of the audiovisual content.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Due to the ease of accessibility and hands-free characteristics of smart glasses, smart glasses are becoming ubiquitous for the generation of audiovisual content for social networks and other social platforms. While off-the-shelf video editing capabilities that are used to generate the audiovisual content for smart glasses have advanced substantially, creators and users of the smart glasses still have substantial issues when editing audiovisual content. For example, adding music or audio effects to video using the smart glasses is often cumbersome and inefficient due to the number of steps and processing power required to add the music and audio effects to the videos. Furthermore, current techniques used to add music or audio effects to video do not appropriately rectify the above issues since the current techniques generally require the manual editing of the audiovisual content. Therefore, a need exists to address the above issues.

### BRIEF DESCRIPTION OF THE DRAWINGS

FIG. 1 is a diagram of a headset in accordance with some embodiments;

FIG. 2 is a block diagram of an example environment in accordance with some embodiments;

FIG. 3 is an audiovisual content generation unit in accordance with some embodiments;

FIG. 4 is flowchart diagram illustrating a method for generating audiovisual content in accordance with embodiments; and

FIG. 5 is a block diagram of a computing environment according to an example implementation of the present disclosure.

### DETAILED DESCRIPTION

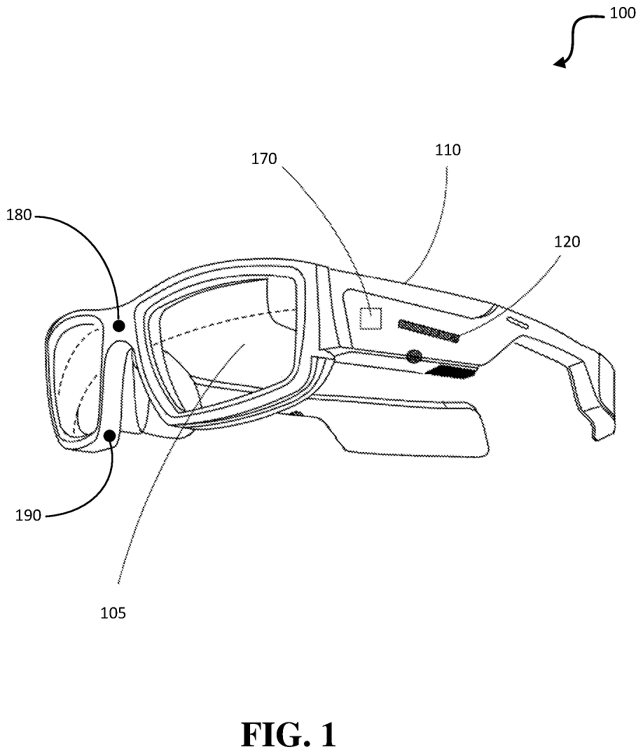

FIG. 1 illustrates a diagram of a headset 100 in accordance with one or more embodiments. In some embodiments, the headset 100 includes a display 105, a video camera 180, a microphone 190, a controller 170, a speaker 120, and a frame 110. In some embodiments, the frame 110 enables the headset 100 to be worn on a face of a user of the headset 100 and houses the components of the headset 100. In one embodiment, the headset 100 may be a head mounted display (HMD). In another embodiment, the headset 100 may be a near eye display (NED). In some embodiments, the headset 100 may be worn on the face of the user such that audiovisual content generated using the audiovisual content generation features described herein is presented using the headset 100. In some embodiments, audiovisual content may include audio content and visual content that is presented to the user via the speaker 120 and the display 105, respectively. In some embodiments, the audiovisual content generated by the headset 100 may be provided to other electronic display devices for display to additional users or creators of audiovisual content.

In some embodiments, the display 105 presents the visual content of the audiovisual content to the user of the headset 100. In some embodiments, the visual content may be video content recorded by the video camera 180 of the headset 100 or video content recorded by a video camera external to the headset 100. In some embodiments, the display 105 may be an electronic display element, such as a liquid crystal display (LCD), an organic light emitting diode (OLED) display, a quantum organic light emitting diode (QOLED) display, a transparent organic light emitting diode (TOLED) display, some other display, or some combination thereof. In some embodiments, the display 105 may be backlit. In some embodiments, the display 105 may include one or more lenses configured to augment the video observed by the user while wearing the headset 100.

In some embodiments, the speaker 120 presents the audio content of the audiovisual content to the user of the headset 100. In some embodiments, the audio content may include audio, such as music, advertisements, and other audio effects, incorporated (either automatically or with human assistance) into the audio presented to the user based on the context of the video content and audio content recorded by the headset 100 or other external device. In some embodiments, the audio content is incorporated into audio content recorded by the headset 100 such that the user does not have to manually edit the audio content to add audio content to the video content. In some embodiments, the audiovisual content generated by the headset 100 is presented to the user of the headset 100.

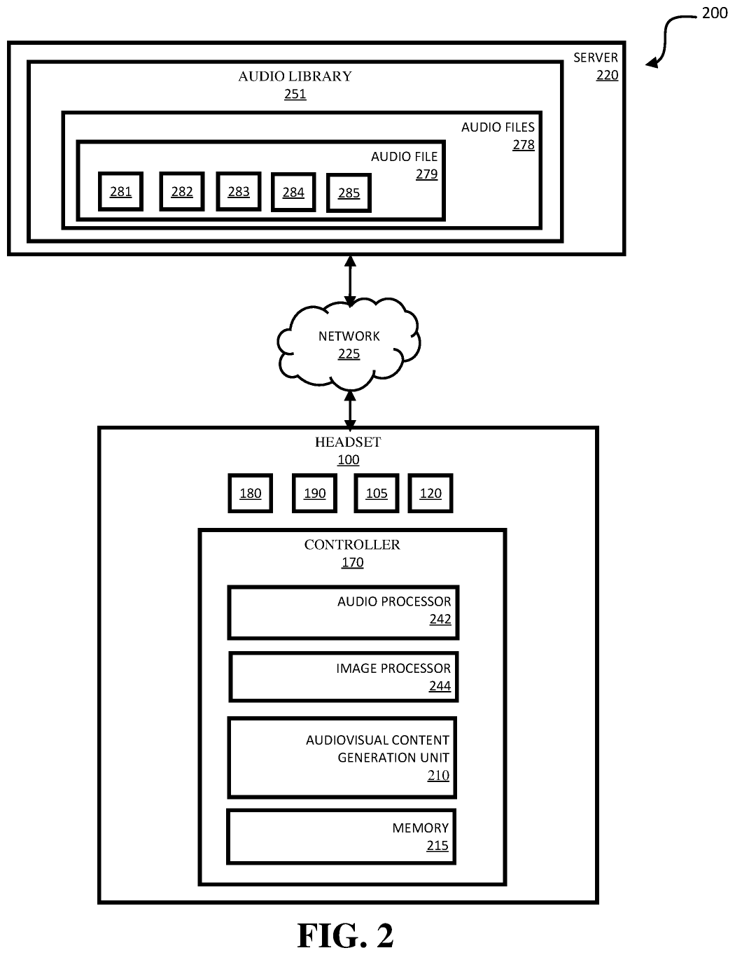

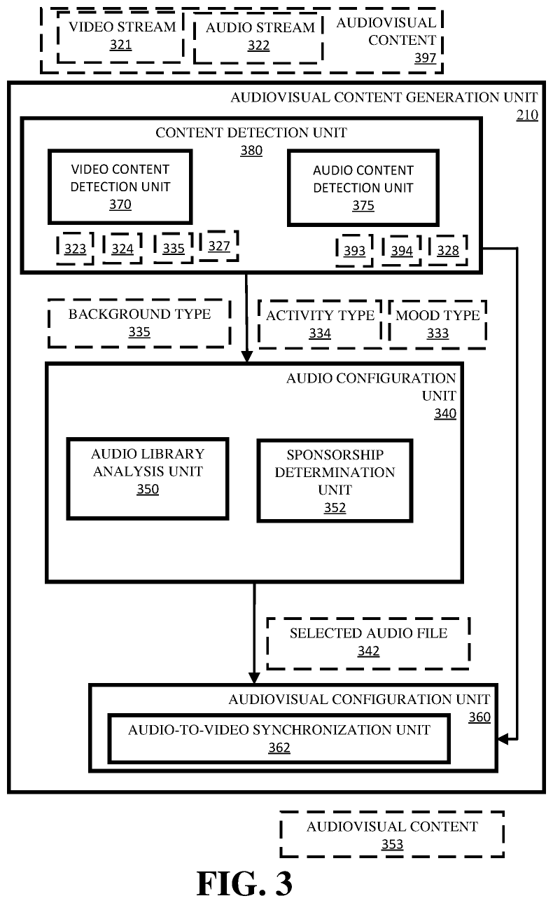

FIG. 2 illustrates an environment 200 in accordance with some embodiments. In some embodiments, the environment 200 includes a server 220, a network 225, and headset 100 of FIG. 1. In some embodiments, the headset 100 includes display 105, video camera 180, microphone 190, speaker 120, and controller 170. In some embodiments, the controller 170 of headset 100 includes an audio processor 242, an image processor 244, an audiovisual content generation unit 210, and memory 215. In some embodiments, the image processor 244 is a processor configured to recognize and detect content within a video stream provided to the image processor 244. In some embodiments, the audio processor 242 is a processor configured to recognize and detect content within an audio stream provided to the audio processor 242. In some embodiments, the audio processor 242 and the image processor 244 are configured to recognize or detect an activity type of a target (e.g., an individual or individuals) of the audiovisual content, a mood type of the target of the audiovisual content, and background type of the video content of the audiovisual content (described further herein with reference to FIG. 3). In some embodiments, audiovisual content generation unit 210 is processing logic (e.g., hardware, software, or a combination of both) configured to generate audiovisual content using the content detection capabilities provided by audio processor 242 and image processor 244 to select and incorporate audio files (e.g., music, advertisements, and other audio effects) into audiovisual content presented to the user of headset 100.

In some embodiments, the server 220 includes an audio library 251 that includes a plurality of audio files 278. In some embodiments, the audio files 278 are audio files, such as, music files, advertisements, or other audio effects that are incorporated into audiovisual content that is presented to the user of headset 100. In some embodiments, the audio files 278 include attribution identification tags that are configured to be used to identify the audio files for use in incorporation of the audio files into the audiovisual content generated by the audiovisual content generation unit 210 (described further in detail herein).

In some embodiments, the attribution identification tags include, for example, an activity type 281, a mood type 282, a background type 283, and a sponsor indicator 284. In some embodiments, the activity type 281 is an indicator of the type of activity the audio file may be associated with, the mood type 282 is an indicator of the type of mood the audio file may be associated with, the background type 283 is an indicator of the type of background the audio file may be associated with, and the sponsor indicator 284 is an indicator of a sponsor the audio file may be associated with (e.g., for advertising or other purposes).

In some embodiments, the activity type 281 may be, for example, a running activity, a walking activity, a climbing activity, a construction activity, a sports related activity, a relationship activity, or any other type of activity capable of being recorded and recognized by audiovisual content generation unit 210. In some embodiments, the mood type 282 may be, for example, a bad mood type, a happy mood type, a sad mood type, an upset mood type, a lonely mood type, a loving mood type, or any other type of mood capable of being recognized by audiovisual content generation unit 210. In some embodiments, the background type 283 may be, for example, a construction background type, a mountainous background type, an athletic event background type, a bedroom background type, a living room background type, a kitchen background type, or any other background type capable of being recognized by audiovisual content generation unit 210. In some embodiments, the sponsor indicator 284 may be, for example, a corporation name, an institution name, a name of a product, a musician, or any other sponsor or name of a sponsor that may request the audio file be used to sponsor or promote a product, music, or service in the audiovisual content generated by audiovisual content generation unit 210.

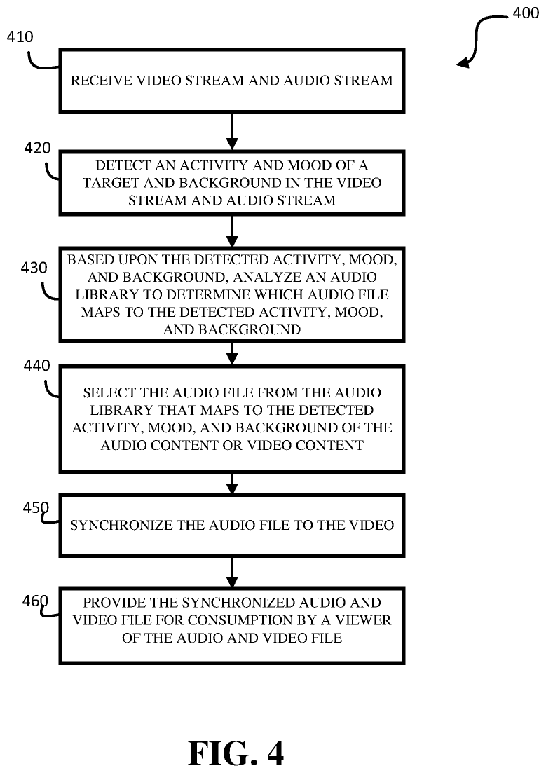

In some embodiments, the headset 100 is configured to record a video stream and an accompanying audio stream using video camera 180 and microphone 190 (or receive the video stream and accompanying audio stream from an external electronic device). In some embodiments, the audiovisual content generation unit 210 of the headset 100 receives the video stream and audio stream and utilizes the image processor 244 and/or audio processor 242 to determine the background of the video content and the activity and mood of a target in the received video steam and audio stream. In some embodiments, the audiovisual content generation unit 210 utilizes the activity, mood, and background discerned from the video stream and audio stream to select an audio file from the audio library 251 that maps to an activity type (e.g., activity type 281), a mood type (e.g., mood type 282), a background type (e.g., background type 283), or a sponsor indicator (sponsor indicator 284) associated with an audio file (e.g., audio file 279) in audio files 278. In some embodiments, the selected audio file is incorporated into audiovisual content that is presented to a user for audiovisual consumption (e.g., viewed on display 105 and listened to using speaker 120 of headset 100). In some embodiments, the incorporation of the selected audio file into the audiovisual content is an improvement over other video editing and audio editing techniques in that no input from the user of the headset 100 is required to edit the audio incorporated into the audiovisual content. The generation of the audiovisual content is described further in detail with reference to FIG. 3 and FIG. 4.

FIG. 3 illustrates an audiovisual content generation unit 210 in accordance with some embodiments. In some embodiments, the audiovisual content generation unit 210 includes a content detection unit 380, an audio configuration unit 340 and an audiovisual configuration unit 360. In some embodiments, the content detection unit 380 includes a video content detection unit 370 and an audio content detection unit 375. In some embodiments, the audio configuration unit 340 includes an audio library analysis unit 350, and a sponsorship determination unit 352. In some embodiments, the audiovisual configuration unit 360 includes an audio-to-video synchronization unit 362. In some embodiments, the content detection unit 380, the audio configuration unit 340 and the audiovisual configuration unit 360 are collectively configured to select and incorporate audio files, such as, for example, music, advertisements, and other audio effects, into audiovisual content presented to display using headset 100.

In some embodiments, the content detection unit 380 is software configured to determine a background type of video content of a video stream 321 and a mood type and activity type of a target or targets of the video stream 321 and an audio stream 322 provided to audiovisual content generation unit 210. In some embodiments, a target may be, for example, an individual or individuals that are the focus of the audiovisual content 397. In some embodiments, as stated previously, the content detection unit 380 includes the video content detection unit 370 and the audio content detection unit 375. In some embodiments, the video content detection unit 370 is software configured to identify a mood type 323 of the target in video content represented by a video stream 321, an activity type 324 of the target of the video content represented by the video stream 321, and a background type 335 of the video content represented by the video stream 321. In some embodiments, the audio content detection unit 375 is software configured to analyze an audio stream 322 and determine a mood type 393 of the target in the audio content represented by the audio stream 322 and an activity type 394 of the target of the audio content represented by the audio stream 322. In some embodiments, the audio content detection unit 375 is software executed by audio processor 242 and the video content detection unit 370 is software executed by image processor 244. In some embodiments, content detection unit 380 is configured to select a mood type 333 and an activity type 334 from the mood type 323, the activity type 324, the mood type 323 and the activity type 324 output by the video content detection unit 370 and the audio content detection unit 375. In some embodiments, the content detection unit 380 selects the mood type 333 and the activity type 334 based upon the probability that the selected mood type 333 and the selected activity type 334 represent the accurate mood type and activity type of the target of the video content.

In some embodiments, in operation, content detection unit 380 receives video stream 321 and audio stream 322 (e.g., audiovisual content 397) recorded by, for example, video camera 180 and microphone 190 and commences the process of analyzing the video content of the video stream 321 and the audio content of audio stream 322 to determine which audio file of audio files 278 to incorporate into the audiovisual content 397. In some embodiments, the video stream 321 and audio stream 322 may be received from, for example, server 220, memory 215, or directly from video camera 180 and microphone 190. In some embodiments, video content detection unit 370 analyzes the video stream 321 and determines an activity type 324 of the target of the video content represented by the video stream 321, a mood type 323 of the target in the video content represented by the video stream 321, and the background type 335 of the video content represented by the video stream 321.

In some embodiments, the audio content detection unit 375 analyzes the audio stream 322 and determines a mood type 393 of the target in the audio content represented in the audio stream 322 and an activity type 394 of the target of the audio content represented in the audio stream 322. In some embodiments, after determining the mood type 323, activity type 324, mood type 393, and activity type 394, content detection unit 380 selects from the mood type 323 and the activity type 324 and the mood type 323 and the activity type 324, the mood type and activity type as mood type 333 and activity type 334. In some embodiment, after content detection unit 380 determines the activity type 334 and the mood type 333 of the target of the audiovisual content 397 and the background type 335 of the video content, the content detection unit 380 provides the activity type 334, the mood type 333, and the background type 335 to audio configuration unit 340.

In some embodiments, audio configuration unit 340 receives the activity type 334, the mood type 333, and the background type 335 from content detection unit 380 and commences the process of analyzing the activity type 334, the mood type 333, and the background type 335 in order for audiovisual content generation unit 210 to incorporate audio, such as audio file 279, into the audiovisual content 397. In some embodiments, audio library analysis unit 350 of audio configuration unit 340 receives the mood type 333, the activity type 334, and the background type 335 and analyzes audio files 278 in audio library 251 to ascertain an audio file that maps to the mood type 333, the activity type 334, and the background type 335 provided by content detection unit 380.

In some embodiments, for example, when content detection unit 380 determines that the activity type 334 is a running activity type, the mood type 333 is a happy mood type, and the background type 335 is a gymnasium background type, the audio library analysis unit 350 selects an audio file 279 that maps to the running activity type, the happy mood type, and the gymnasium background type from the audio library 251. For example, audio library analysis unit 350 conducts an analysis of audio library 251 and determines that an audio file 279 titled, “Gonna Fly Now” from the motion picture Rocky has an activity type, a mood type, and a background type that is equivalent to the mood type 333, the activity type 334, and/or the background type 335 provided by content detection unit 380. In some embodiments, the audio library analysis unit 350 selects the audio file 279 that maps to the running activity type, the happy mood type, and the gymnasium background type from the audio library 251. In some embodiments, audio configuration unit 340 provides the selected audio file 342 (e.g., audio file 279) to audiovisual configuration unit 360.

In some embodiments, audiovisual configuration unit 360 receives the selected audio file 342 and synchronizes the selected audio file 342 to video stream 321 using audio-to-video synchronization unit 362. In some embodiments, audio-to-video synchronization unit 362 is software configured to synchronize the selected audio file 342 with the video stream 321 such that the audio representing a particular mood or activity plays in the background of the video content of video stream 321. In some embodiments, for example, in order to align a detected activity, mood, and/or background of the video stream 321 with the relevant activity, mood, and/or background of the selected audio file 342, a video stream timing marker 327 and audio stream timing marker 328 are placed by, for example, content detection unit 380, at the location of the detected activity, mood, sponsor, and/or background in the video stream 321 and audio stream 322. Likewise, in some embodiments, an audio file marker 285 is placed in the audio files 278 (e.g., audio file 279) at the location of an activity, sponsor, mood, and/or background, of the selected audio file 342 (e.g., audio file 279). In some embodiments, in order to place the audio file marker 285 in the audio files 278, audiovisual content generation unit 210 scans the audio files 278 and determines the locations in the audio files 278 where relevant moods, activities, and/or a product of a sponsor are present. In some embodiments, the video stream timing marker 327 is a marker placed in the video stream 321 that is indicative of the timing and type of activity and/or mood present at the location of the video stream 321. In some embodiments, the audio stream timing marker 328 is a marker placed in the audio stream 322 that is indicative of the timing and type of activity and/or mood present at the location of the audio stream 322.

In some embodiments, with further reference to FIG. 3, after selecting the audio file from audio files 278 (e.g., selected audio file 342) that maps to the video stream 321, audio-to-video synchronization unit 362 aligns the video stream timing marker 327 with the matching audio file marker 285 of the selected audio file 342 such that the corresponding selected audio file 342 is played at the video streaming time marker 327 location of the video stream 321. Similarly, in some embodiments, after selecting the audio file from audio files 278 that maps to the audio stream 322, audio-to-video synchronization unit 362 aligns the audio stream timing marker 328 with a matching audio file marker 285 of the selected audio file 342 such that the corresponding selected audio file 342 is played at the audio stream timing marker 328 location of the audio stream 322.

In some embodiments, after synchronizing the video stream timing marker 327 with the matching audio file marker 285 of the selected audio file 342 or the audio stream time marker 328 with the matching audio file marker 285, audiovisual configuration unit 360 provides the synchronized selected audiovisual content 353 (e.g., selected audio file 342 and video stream 321) for audiovisual consumption in headset 100. In some embodiments, the synchronized audiovisual content 353 may be provided to other electronic devices, such as a personal computer, tablet, or the like, for view in other displays.

FIG. 4 is a process flow diagram illustrating a method 400 for incorporating audio into audiovisual content in accordance with some embodiments. In some embodiments, method 400 may be performed using processing logic that includes hardware, software, or a combination thereof. In some embodiments, the hardware may include, for example, programmable logic, decision making logic, dedicated logic, application-specific integrated circuits (ASIC), etc. In some embodiments, the processing logic refers to one or more elements of an electronic device, such as, for example, headset 100 or server 220 of FIG. 1 and FIG. 2. In some embodiments, operations of method 400 may be implemented in an order different than described herein or shown in FIG. 4. In some embodiments, method 400 may have additional or less operations not shown herein.

In some embodiments, at block 410, content detection unit 380 receives a video stream 321 recorded using a video camera (e.g., video camera 180) and an audio stream 322 recorded using a microphone (e.g., microphone 190). In some embodiments, content detection unit 380 may receive the video stream 321 and corresponding audio stream 322 from server 220, memory 215, or a database.

In some embodiments, at block 420, the content detection unit 380 analyzes the video stream 321 and audio stream 322 and determines the activity type 334 of the target of the video content represented by the video stream 321 and audio stream 322, the mood type 333 of the target in the video content represented by the video stream 321 and audio stream 322, and the background type 335 of the video content represented by the video stream 321. In some embodiments, content detection unit 380 also determines the video stream timing marker 327 (indicative of the location of the activity and mood in the video stream 321) and the audio stream timing marker 328 (indicative of the location of the activity and mood in the audio stream 322). In some embodiments, as stated previously, content detection unit 380 uses image processing provided by image processor 244 to detect the activity type, the mood type, and the background type of the video stream 321, and to generate the video stream timing marker 327. In some embodiments, content detection unit 380 uses audio processing provided by audio processor 242 to detect the activity type, the mood type, and the background type of the audio stream 322, and to generate the audio stream timing marker 328.

In some embodiments, at block 430, based on the detected the mood type 333, the activity type 334, and the background type 335, audio configuration unit 340 analyzes audio files 278 in audio library 251 to determine the audio file to incorporate into the audiovisual content 397 represented by video stream 321 and audio stream 322.

In some embodiments, at block 440, audio library analysis unit 350 selects an audio file from audio files 278 as the selected audio file 342 that maps to the mood type 333, the activity type 334, and the background type 335 detected by content detection unit 380. In some embodiments, the selected audio file 342 is provided to audiovisual configuration unit 360.

In some embodiments, at block 450, the audiovisual configuration unit 360 synchronizes the selected audio file 342 to the video content represented by video stream 321. In some embodiments, at block 460, the synchronized selected audio file 342 (e.g., audio file 279) and video stream 321 are presented as audiovisual content 353 to the display 105 and speaker 120 for view and audio listening pleasure by the wearer of the headset 100.

In alternate embodiments, a user may record video and accompanying audio of a target, such as a person or animal, running happily in a park and provide the video and accompanying audio as audiovisual content 397 to audiovisual content generation unit 210. In some embodiments, content detection unit 380 of audiovisual content generation unit 210 analyzes the audiovisual content 397 and determines that the activity type 334 being performed by the target is a running activity, the mood type 333 of the target is a happy mood, and that the background type 335 of the audiovisual content 397 is a park background. In some embodiments, content detection unit 380 provides the activity type 334 (e.g., running activity), the mood type 333 (e.g., happy mood), and the background type 335 (e.g., park background) to audio configuration unit 340. In some embodiments, the audio library analysis unit 350 of audio configuration unit 340 receives the activity type 334, the mood type 333 and the background type 335 and analyzes the audio files 278 in the audio library 251 to ascertain an audio file or audio files that map to the activity type 334, the mood type 333 and the background type 335. In some embodiments, audio library analysis unit 350 analyzes the audio files 278 in the audio library 251 by comparing the activity type 334 (e.g., running activity), the mood type 333 (e.g., happy mood), and the background type 335 with the activity type (e.g., activity type 281), the mood type (e.g., mood type 282), and the background type (e.g., background type 283) associated with each audio file of audio files 278. In some embodiments, based upon the analysis, audio library analysis unit 350 selects a plurality of audio files from audio library 251 that map to the running activity, the happy mood, and the park background. In some embodiments, the audio configuration unit 340 provides the titles of the plurality of audio files to display 105 for view by the user of headset 100, to allow the user to select the desired audio file to play in the background of the video content of video stream 321 (audiovisual content 397). In some embodiments, the user views the titles of the audio files presented on display 105 and selects the desired audio file, such as, for example, an ironic clown car song, using an audio command via microphone 190 or other input selection medium (such as, e.g., a hand gesture in a virtual or augmented reality system). In some embodiments, the selected audio file 342 is provided to audiovisual configuration unit 360, which synchronizes the selected audio file 342 with the video content of video stream 321 to generate audiovisual content 353.

In alternate embodiments, a user may record video and accompanying audio of a target hammering a nail into a bedroom wall, hitting their thumb, and screaming in pain. In some embodiments, the user provides the video as video stream 321 and accompanying audio as audio stream 322 (e.g., audiovisual content 397) to audiovisual content generation unit 210. In some embodiments, content detection unit 380 of audiovisual content generation unit 210 analyzes the audiovisual content 397 and determines that the activity type 334 being performed by the target is a carpentering activity, the mood type 333 of the target is an upset mood (e.g., from the audio stream 322), and the background type 335 of the video is a bedroom background. In some embodiments, content detection unit 380 provides the activity type 334 (e.g., carpentering activity), the mood type 333 (e.g., upset mood), and the background type 335 (e.g., bedroom background) to audio configuration unit 340. In some embodiments, the audio library analysis unit 350 of audio configuration unit 340 receives the activity type 334, the mood type 333 and the background type 335 and analyzes the audio files 278 in the audio library 251. In some embodiments, the audio library analysis unit 350 analyzes the audio files 278 by comparing the activity type 334 (e.g., carpentering activity), the mood type 333 (e.g., upset mood), and the background type 335 (e.g., bedroom background) with the activity type (e.g., activity type 281), the mood type (e.g., mood type 282), and the background type (e.g., background type 283) associated with each audio file of audio files 278. In some embodiments, based on the analysis, audio library analysis unit 350 selects an audio file that has the same the activity type, mood type, and/or background type, such as, for example, the song “So You Had a Bad Day” by Daniel Powter. In some embodiments, the selected audio file 342 is provided to audiovisual configuration unit 360, which synchronizes the selected audio file 342 with the video content of video stream 321 to generate audiovisual content 353. In some embodiments, the audiovisual configuration unit 360 synchronizes the selected audio file 342 with video content of the video stream 321 and/or audio content of the audio stream 322 such that the chorus of the selected audio file 342 starts or plays when the target performs the activity (e.g., hits a thumb), experiences the mood (e.g., painful mood), or displays a sponsor (e.g., BRAND of hammer) in the video content or audio content. In some embodiments, the audiovisual configuration unit 360 is configured to edit or crop the music of the selected audio file 342 such that the music plays only during the activity (e.g., the audio file plays when the activity starts and stops playing when the activity ends). In some embodiments, the audiovisual configuration unit 360 is configured to edit the audio content of audio stream 322 such that specific words or verbiage may filtered or muted, such as, for example, a swear word. In some embodiments, only the audio selected (e.g., selected audio file 342) is played in the background of the video content of video stream 321 when a specific word is muted. In some embodiments, the edited version of the audiovisual content (e.g., audiovisual content 353) is uploaded automatically to memory 215 of headset 100. In some embodiments, the synchronized selected audio file 342 and the video stream 321 are provided as audiovisual content 353 for audiovisual consumption using headset 100.

In alternate embodiments, a user records audiovisual content 397 (e.g., a video and audio) of a target running into a wall. In some embodiments, the user selects an audio file from audio library 251 to incorporate into the audiovisual content 397 that is a heavy metal song that includes a swear word. In some embodiments, headset 100 determines that the audiovisual content is to be viewed on display 105 by a child (due to, for example, a swear word filter being implemented on the headset 100). In some embodiments, based the audio configuration unit 340 recognizing that a swear word filter has been initiated, the audio configuration unit 340 selects a replacement audio file with a matching background type 335, activity type 334, and mood type 333, but no swear words, and synchronizes the replacement audio file with the video content of video stream 321 to create audiovisual content 353. In some embodiments, using the audiovisual content generation unit 210, the audio file with swear words is replaced as the accompanying audio to the video stream 321 with an audio file without swear words that is similar to the original audio file selected by the user (e.g., a similar song selected without swear words based on the analysis by audio library analysis unit 350).

In alternate embodiments, the headset 100 is configured to distribute audiovisual content 353 to other members of a social network associated with a user of the headset 100 via network 225. For example, in some embodiments, based on an analysis of video content of video streams associated with the other members in the social network, the headset 100 may select an audio file 279 that maps to the activity type 334, the mood type 333, and the background type 335 liked by another member or members of the social network. In some embodiments, the audiovisual content 353 is provided via network 225 to the other members of the social network associated with the user.

In alternate embodiments, instead of the audio configuration unit 340 selecting the selected audio file 342, the audio configuration unit 340 may provide a plurality of audio files that meet criteria for selection (e.g., the activity type 334, the mood type 333, and/or background type 335), and present the plurality of audio files to the user of the headset 100 for selection. In some embodiments, the user selects the desired audio file from the plurality of audio files based on the preference of the viewer of the audiovisual content or the creator of the audiovisual content. In some embodiments, audiovisual content generation unit 210 provides selected audio file 342 as background audio for the audiovisual content 353.

In some embodiments, the audio configuration unit 340 is configured to mine the selection options to improve recommendations based on, for example, a population for which the audio files are selected. In some embodiments, an audio file is selected based on, for example, a market of the creator of the audiovisual content or a market of the viewer of the audiovisual content. In some embodiments, the audio configuration unit 340 is configured to promote audio files (e.g., songs and options for purchase) based on, for examples, heuristics or promotions provided by, for example, a company or other commercial entity, an owner of the audio files, a creator of the audio files (e.g., musician, producer).

In some embodiments, the audio configuration unit 340 is configured to perform the operations herein automatically, without direct input from the creator or viewer of the audiovisual content.

In some embodiments, the audio configuration unit 340 is configured to modify or change the play rate of the audiovisual content (e.g., video or song or both the video and song) to synchronize the audio file 279 to the images in the video content (e.g., align the music with the images in the video).

In some embodiments, video content detection unit 370 is configured to detect tempo patterns in the video content of the video stream or the audio content detection unit 375 and use the detected tempo patterns to select an audio file 279 that matches with the tempo patterns of the video content or audio content. In some embodiments, for example, when a song detected by content detection unit 380 in the audiovisual content 397 has a tempo of 120 beats per minute, audio library analysis unit 350 may select a replacement song (having similar incorporation attributes) as selected audio file 342 with a tempo of 120 beats per minute.

In alternate embodiments, a corporation or sponsor may request that a promotional video utilize a specific audio file (e.g., a specific song) from audio files 278 to promote a specific product. In some embodiments, the company may record the promotional video of a target with a product wherein the target performs a specific activity with the product. In some embodiments, the content detection unit 380 of audiovisual content generation unit 210 is configured to detect product specific audio or video content (e.g., what the target is talking about or how the target is using the product) in the received promotional video. In some embodiments, audiovisual content generation unit 210 selects, recommends or automatically adds an audio file of a selected song or jingle to the audiovisual content. In some embodiments, the sponsorship determination unit 352 is configured to determine the sponsor that is requesting sponsorship using, for example, the promotional video. In some embodiments, the video and corresponding audio is automatically tagged as promotional audiovisual content and uploaded to the memory 215 of headset 100 for promotional purposes and view on display 105.

In some embodiments, a song writer or musician may request that a song written by the song writer or played by the musician be used for audiovisual content that includes specific activity types or background types, such as, for example, a sunny background and or a beach background. In some embodiments, audio library analysis unit 350 selects a plurality of audio files 279 for selection by the user of the headset 100. In some embodiments, while presenting the audio files 279 that map to the video content of video stream 321, audio configuration unit 340 promotes an audio file, e.g., audio file 279, associated with the songwriter or musician such that the song associated with the songwriter or musician is more likely to be selected by the user of the headset 100.

In some embodiments, a plurality of videos that include audio files from audio files 278 associated with a musician (via ownership or the like) may be used to create a feed accessible to the musician or others via a link or a website. In some embodiments, when, for example, an individual with ownership authority of audio files of audio files 278 requests that audio files be played only in an enumerated set of countries, the audiovisual content generation unit 210 may only play the audio files in the enumerated set of countries. In some embodiments, the audiovisual content generation unit 210 assesses the location of the user of the headset 100 and applies the audio files (e.g., songs) to videos when a user of the headset 100 is in the country or specific set of countries and opens a video with approved content based on, for example, a ranking (e.g., high ranking) in an audio file ranking system.

In alternate embodiments, during the synchronization process, the audiovisual configuration unit 360 is configured to utilize the audio-to-video synchronization unit 362 to adjust the timing of the music represented by the audio file 279 based on the content of the video or audio.

In alterate embodiments, the audio library analysis unit 350 is configured to classify the audio files 278 using automatic music library tagging which may automatically classify songs by genre, a user's genre preferences, a tempo of the audio file, lyrics in the audio file, a mood of the audio file, and/or a popularity of the audio file. In some embodiments, the audio library analysis unit 350 is configured to classify audio effects provided by the audio library using a name of the audio effect or an associated search query of the audio effect. In some embodiments, the audio effects may be used to generate the audiovisual content 353.

In alternate embodiments, the audiovisual content generation unit 210 is configured to utilize a historical analysis to generate the audiovisual content 353. In some embodiments, a user history identifies a user's previous selections of music or audio effect recommendations and music listening preferences. In some embodiments, a network history identifies a social network's previous selections of music or audio effects for similar captured content. In some embodiments, the user history and/or network history is utilized to select the audio file from audio files 278 and generate the audiovisual content 353.

In alternate embodiments, with further reference to FIG. 3, the content detection unit 380 is configured to perform a captured audiovisual content analysis, which includes a visual scene understanding, an acoustic scene understanding, a context understanding, and error correction of the audiovisual content 397. In some embodiments, the visual scene understanding of the captured audiovisual content 397 includes in-frame, e.g., activities and actions of objects and people, including their classification, repetitive patterns (e.g., tempo, beats), and relationships to each other, progression curve of events and activities, and place and event classifications. In some embodiments, the acoustic scene understanding of the captured audiovisual content 397 includes classification of events, people, places, and background noise, and speech characteristics (such as, e.g., timbre, tone, intonation, and mental state). In some embodiments, the context understanding of the captured audiovisual content 397 includes an understanding of device permissions, such as, for example, for the user's location or social context (e.g., the relationship of the audiovisual content 397 to a user's contacts and events (e.g., ‘Family Vacation in Mexico,’ ‘Dinner With Friends,’ or ‘My Birthday party’)). In some embodiments, the error correction may be utilized to compare and match visual, acoustic, and context parameters to improve accuracy of the collective understanding of the content.

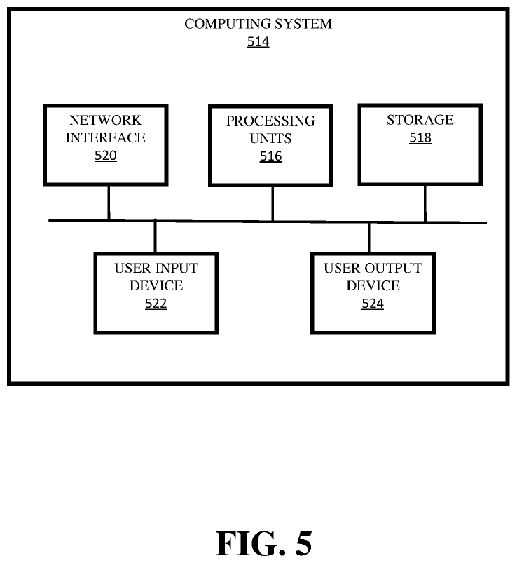

Various operations described herein can be implemented on computer systems. FIG. 5 shows a block diagram of a representative computing system 514 usable to implement the present disclosure. In some embodiments, the operations of headset 100 or the server 220 of FIG. 2 is implemented by the computing system 514. Computing system 514 can be implemented, for example, as a consumer device such as a smartphone, other mobile phone, tablet computer, wearable computing device (e.g., smart watch, eyeglasses, head mounted display), desktop computer, laptop computer, or implemented with distributed computing devices. The computing system 514 can be implemented to provide VR, AR, MR experience. In some embodiments, the computing system 514 can include conventional computer components such as processors 516, storage device 518, network interface 520, user input device 522, and user output device 524.

Network interface 520 can provide a connection to a wide area network (e.g., the Internet) to which WAN interface of a remote server system is also connected. Network interface 520 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 522 can include any device (or devices) via which a user can provide signals to computing system 514; computing system 514 can interpret the signals as indicative of particular user requests or information. User input device 522 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 524 can include any device via which computing system 514 can provide information to a user. For example, user output device 524 can include a display to display images generated by or delivered to computing system 514. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 524 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 516 can provide various functionality for computing system 514, including any of the functionality described herein as being performed by a server or client, or other functionality associated with message management services.

It will be appreciated that computing system 514 is illustrative and that variations and modifications are possible. Computer systems used in connection with the present disclosure can have other capabilities not specifically described here. Further, while computing system 514 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing, various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

In some embodiments, a method includes detecting an incorporation attribute of audiovisual content; analyzing an audio library to determine an audio file that maps to the incorporation attribute; selecting the audio file from the audio library that maps to the incorporation attribute; incorporating the selected audio file into the audiovisual content to generate egocentric audiovisual content; and providing the egocentric audiovisual content to a user for audiovisual consumption.

In some embodiments of the method, the incorporation attribute is at least one of a mood of a target of the audiovisual content, an activity of the target of the audiovisual content, and a background of the audiovisual content.

In some embodiments of the method, the audiovisual content includes video content of a video stream and audio content of an audio stream.

In some embodiments, the method further includes synchronizing the selected audio file to the audiovisual content based upon an audio file marker placed in the audio file.

In some embodiments, the method further includes mapping audio files in the audio library to at least one of an activity type, a mood type, a background type, and a sponsorship type.

In some embodiments of the method, an audio configuration unit selects the audio file based upon the mapping of the audio file to the incorporation attribute.

In some embodiments of the method, an audio library analysis unit analyzes the audio library to determine which audio file in the audio library maps to the incorporation attribute of the audiovisual content.

In some embodiments of the method, synchronizing the audio file to a video stream of the audiovisual content is dependent upon a video stream timing marker being placed in the video stream of the audiovisual content.

In some embodiments of the method, synchronizing the audio file to the video stream is dependent upon an audio stream time marker being placed in the audio stream.

In some embodiments, a system includes a video recorder; an audio recorder coupled to the video recorder; and a controller coupled to the video recorder and the audio recorder, wherein the controller is configured to: detect an incorporation attribute of audiovisual content; analyze an audio library to determine an audio file that maps to the incorporation attribute; select the audio file from the audio library that maps to the incorporation attribute; incorporate the selected audio file into the audiovisual content to generate egocentric audiovisual content; and provide the egocentric audiovisual content to a user for audiovisual consumption.

In some embodiments of the system, the incorporation attribute is at least one of a mood of a target of the audiovisual content, an activity of the target of the audiovisual content, and a background of the audiovisual content.

In some embodiments of the system, the audiovisual content includes video content of a video stream and audio content of an audio stream.

In some embodiments of the system, the selected audio file is synchronized to the audiovisual content based upon an audio file marker placed in the audio file.

In some embodiments of the system, audio files in the audio library are mapped to at least one of an activity type, a mood type, a background type, and a sponsorship type.

In some embodiments of the system, an audio configuration unit selects the audio file based upon the mapping of the audio file to the incorporation attribute.

In some embodiments of the system, an audio library analysis unit analyzes the audio library to determine which audio file in the audio library maps to the incorporation attribute of the audiovisual content.

In some embodiments of the system, the audio file is synchronized to a video stream of the audiovisual content using a video stream timing marker that is placed in the video stream of the audiovisual content.

In some embodiments of the system, the audio file that is synchronized to a video stream of the audiovisual content using an audio stream time marker that is placed in the audio stream of the audiovisual content.

In some embodiments, a non-transitory computer-readable medium storing instructions that, when executed by one or more processors, cause the one or more processors to perform operations including: detecting an incorporation attribute of audiovisual content; analyzing an audio library to determine a first audio file that maps to the incorporation attribute of the audiovisual content; selecting the first audio file from the audio library that maps to the incorporation attribute; incorporating the selected first audio file into the audiovisual content to generate egocentric audiovisual content; uploading the egocentric audiovisual content to a social network for view by a viewer of the social network; and modifying the egocentric audiovisual content to include a second audio file selected using preferences of the viewer of the egocentric audiovisual content.

In some embodiments of the non-transitory computer-readable medium, the second audio file selected by the viewer of the egocentric audiovisual content replaces the first audio file selected from the audio library that maps to the incorporation attribute.

What is claimed is:

1. A method, comprising:
detecting an incorporation attribute of audiovisual content;
analyzing an audio library to determine an audio file that maps to the incorporation attribute;
selecting the audio file from the audio library that maps to the incorporation attribute;
incorporating the selected audio file into the audiovisual content to generate egocentric audiovisual content; and
providing the egocentric audiovisual content to a user for audiovisual consumption.

2. The method of claim 1, wherein:
the incorporation attribute is at least one of a mood of a target of the audiovisual content, an activity of the target of the audiovisual content, and a background of the audiovisual content.

3. The method of claim 2, wherein:
the audiovisual content includes video content of a video stream and audio content of an audio stream.

4. The method of claim 3, further comprising:
synchronizing the selected audio file to the audiovisual content based upon an audio file marker placed in the audio file.

5. The method of claim 4, further comprising:
mapping audio files in the audio library to at least one of an activity type, a mood type, a background type, and a sponsorship type.

6. The method of claim 5, wherein:
an audio configuration unit selects the audio file based upon the mapping of the audio file to the incorporation attribute.

7. The method of claim 6, wherein:
an audio library analysis unit analyzes the audio library to determine which audio file in the audio library maps to the incorporation attribute of the audiovisual content.

8. The method of claim 7, wherein:
synchronizing the audio file to a video stream of the audiovisual content is dependent upon a video stream timing marker being placed in the video stream of the audiovisual content.

9. The method of claim 8, wherein:
synchronizing the audio file to the video stream is dependent upon an audio stream time marker being placed in the audio stream.

10. A system, comprising:
a video recorder;
an audio recorder coupled to the video recorder; and
a controller coupled to the video recorder and the audio recorder, wherein the controller is configured to:
detect an incorporation attribute of audiovisual content;
analyze an audio library to determine an audio file that maps to the incorporation attribute;
select the audio file from the audio library that maps to the incorporation attribute;
incorporate the selected audio file into the audiovisual content to generate egocentric audiovisual content; and
provide the egocentric audiovisual content to a user for audiovisual consumption.

11. The system of claim 10, wherein:
the incorporation attribute is at least one of a mood of a target of the audiovisual content, an activity of the target of the audiovisual content, and a background of the audiovisual content.

12. The system of claim 11, wherein:
the audiovisual content includes video content of a video stream and audio content of an audio stream.

13. The system of claim 12, wherein:
the selected audio file is synchronized to the audiovisual content based upon an audio file marker placed in the audio file.

14. The system of claim 13, wherein:
audio files in the audio library are mapped to at least one of an activity type, a mood type, a background type, and a sponsorship type.

15. The system of claim 14, wherein:
an audio configuration unit selects the audio file based upon the mapping of the audio file to the incorporation attribute.

16. The system of claim 15, wherein:
an audio library analysis unit analyzes the audio library to determine which audio file in the audio library maps to the incorporation attribute of the audiovisual content.

17. The system of claim 16, wherein:
the audio file is synchronized to a video stream of the audiovisual content using a video stream timing marker that is placed in the video stream of the audiovisual content.

18. The system of claim 16, wherein:
the audio file that is synchronized to a video stream of the audiovisual content using an audio stream time marker that is placed in the audio stream of the audiovisual content.

19. A non-transitory computer-readable medium storing instructions that, when executed by one or more processors, cause the one or more processors to perform operations comprising:
detecting an incorporation attribute of audiovisual content;
analyzing an audio library to determine a first audio file that maps to the incorporation attribute of the audiovisual content;
selecting the first audio file from the audio library that maps to the incorporation attribute;
incorporating the selected first audio file into the audiovisual content to generate egocentric audiovisual content;
uploading the egocentric audiovisual content to a social network for view by a viewer of the social network; and
modifying the egocentric audiovisual content to include a second audio file selected using preferences of the viewer of the egocentric audiovisual content.

20. The non-transitory computer-readable medium of claim 19, wherein:
the second audio file selected by the viewer of the egocentric audiovisual content replaces the first audio file selected from the audio library that maps to the incorporation attribute.
